(19) United States
(12) Patent Application Publication
(10) Pub. No.: US 2002/0081549 A1
(43) Pub. Date: Jun. 27, 2002

(54) Capillary tube

(76) Inventor: Sigurd Malmberg, Ljusstoparegatan (SE)

Correspondence Address: Samuels, Gauthier & Stevens LLP, Suite 3300, 225 Franklin Street, Boston, MA, 02110, US

(21) Appl. No.: 09/860,233

(22) Filed: May 18, 2001

Related U.S. Application Data
(63) Continuation of application No. PCT/SE99/02121, filed on Nov. 18, 1999.

(30) Foreign Application Priority Data
Nov. 20, 1998 (SE) 9803989-4

(51) Int. Cl. A61C 17/00

(52) U.S. Cl. 433/80

(57) ABSTRACT

The present invention relates to a capillary tube for dental purposes, in particular for applying small amounts of dental product in the mouth cavity, whereby it comprises a capillary tube (i) comprising (i) a rear end (2) intended to be introduced into a container for adhesive or other dental filling or repair material, (ii) a front application point (4) which is angled with regard to the main direction of the capillary tube, and (iii) an intermediate part (3) comprising a grip and a stop.

### TECHNICAL FIELD

The present invention relates to a capillary tube for dental purposes, in particular for applying small amounts of dental product in the mouth cavity.

The object of the present invention is to obtain a device for applying a dental product in the mouth cavity in a simple and rational way, in particular for dosing small amounts of dental product.

A further object is to obtain a device for applying adhesive materials in connection with dental care operations.

### BACKGROUND OF THE INVENTION

Within dental care one works today with adhesive materials which are aggressive, in particular allergenic, i.e., they may give raise to alternate reactions.

Adhesive agents are used in an increasing way within dental care, such as at the preserving treatment (mending) using different types of composite materials, cerams, and compomers Further, adhesive cementation of prosthetic constructions and treatment devices, such as at tooth regulation, is used. Other cases are mending of present prosthetic constructions. The adhesive agents used are thereby binding agents between tooth material and any other desired material.

The adhesive compositions are, as a rule, packed in laminated, light protecting polymer bottles or ampoules, whereby even glass flasks can be used. The modern adhesive compositions are cured (polymerized) after application using a filtered visible light having a predetermined wavelength (blue light). The same is true also for most of the filling and repair agents used today, which are used together with the adhesive compositions,

Generally, the adhesive compositions are used in such a way that they are dripped into a so called Dappen glass (a small container of glass or plastic). The composition is then administered via a small foam rubber sponge 10 the area to be treated. Alternatively, the liquid can be dripped onto an application stick and by means of this be applied to the working, area. In all cases the adhesive composition is handled more or less open with several occasions to contaminate the surrounding tissue. The adhesive compositions further comprises volatile solvents which vaporize.

During resent time one has noticed the problem of health risks at the handling of adhesive compositions which health risks are deemed to be serious, in particular to the personal involved, dentists and dental nurses. The health risks are primarily due to a sensitization with subsequent contact allergy problems. The present protecting equipment does not manage to prevent contact with skin and mucous membranes. Thus the latex and vinyl gloves used today, do not provide any real protection as they seem to be permeable to the volatile parts of the adhesive compositions prior to and/or during polymerization. The handling is thus a problem still to be resolved.

SE-B-462 363 describes an auxiliary device of a liquid in the mouth cavity which auxiliary device comprises an application stick which in its end opposite to the application point receives a space for a liquid reservoir which can be broken using a pressure and the liquid can be removed from the rear end of the auxiliary device and be administered by means of the stick. This auxiliary device does not solve the working hygienic problem as the liquid will become distributed over the rear end of the auxiliary device after the breakage using pressure and thereby become very available for contamination of the surrounding.

SE-C-503 656 relates to a container for dental use which container comprises a dappen glass being filled from the container via a tube. Even in this case a stick or foam rubber sponge are used for application of adhesive composition, whereby this construction seems to have a considerable load on the working environment as one turns the container up side down after use and places it within reach for the dentist, whereby the dentist should be very exposed to vaporized products from the container and its dappen glass.

### DESCRIPTION OF THE PRESENT INVENTION

It has now surprisingly turned out possible to be able to eliminate great pans of these problems by means of the present invention which relates to a disposable application instrument which is characterized in that it comprises a capillary tube comprising

(i) a rear end intended to be introduced into a container for adhesive or other dental filling or repair material,

(ii) a front application point which is angled with regard to the main direction of the capillary tube, and

(iii) an intermediate part comprising a grip and A stop.

Further characteristics are evident from the accompanying claims.

By means of the present invention it is achieved that the adhesive composition having the right concentration of solvents reaches the application site, that the adhesive composition can be distributed there in a simple way over the application site as the point is an application means as well, that evaporation to the surrounding from the applicator is directly hindered, that a to early polymerization (curing) of the adhesive composition is avoided, that reinfection of a remaining amount of adhesive composition in the container for adhesive composition is avoided.

The adhesive compositions contain as mentioned above, a volatile solvent such as acetone being a carrier of the adhesive component part of the composition. The solvent has to the function of not only dissolving the adhesive component but also be a carrier thereto, and to suppress liquid present in the application area, such as water and thereby place the adhesive composition “in place” and then become vaporized.

The present invention will be described more in detail in the following with reference to the accompanying drawing which shows a preferred embodiment of the invention however, without being restricted thereto, in which drawing

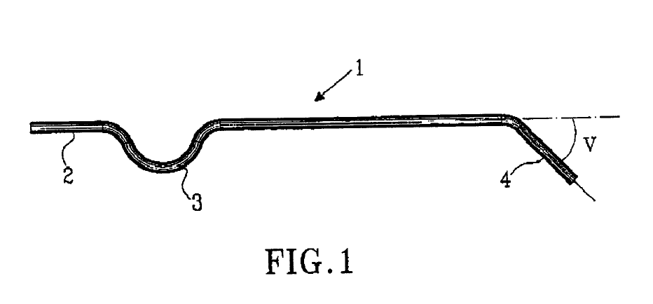

FIG. 1 shows a side view of the capillary tube according to the invention.

1 denotes a capillary tube consisting of an opaque polymer material, such as TEFLON® having a length of about 100 mm and an outer diameter of 1.5 to 2.0 mm. The rear end 2 of the tube I is sightly shaped and arranged to be introduced into a container (not shown) for an adhesive composition) either in the form of a laminated polymer or glass bottle having A pierceable membrane. Immediately in front of the rear end 2, which takes about 15 to 20 mm of the length of the tube, there is a bent part 3 of the tube 1, which bent part is intended to be a natural stop to the introduction in said container, but also be a grip for taking the capillary tube out of its package or from an instrument tray. The bent part can also be a support or guiding grip during the application operation itself The bent part which takes about 15 to 20 mm of the length of the tube is hereby part of a circular arc In the front end 4 of the tube 1 the tube is bent at a distance of 15 to 20 mm from the point at an angle of suitably 40 to 60° with the longitudinal direction of the tube 1. Hereby, a suitable working angle to the operator (dentist) is derived The capillary of the capillary tube opens in the center of the tube 1 and the surface surrounding the capillary is an application tool for an adhesive composition or other material.

When using the present invention this is arranged into a container having the intended material by pressing its rear end 2 through a membrane present or through another closure. The container is leaned whereby the capillary sucks the intended material/composition through the tube and releases it at the opening from where it is applied by the operator at the site of treatment. When a necessary amount has been obtained the container is raised whereby the composition in the container releases its contact with the capillary and the suction action ends. As a capillary is present there is no running back of the composition to the container whereby the risk for bacterial or virus contamination of the composition is being eliminated. By using the tube a greater pan of the risk for another contamination of the mouth cavity but the material is brought to the right site.

Further, it has turned out at practical tests that K opaque polymer material prevents a polymerization of a light polymerizing composition, partly depending on the fact that the concentration of solvent is high enough to prevent polymerization, partly depending on the fact that the polymer material of the capillary provides light protection enough.

By using a polymer material in the manufacture of the capillary tube this can be treated as a disposable capillary and be thrown away after use at a patient. The amount of remaining material in the capillary Is about 1/10 of a drip which, besides, is hardly vaporized through the polymer material of the capillary tube. The working hygienic conditions are thus Food at the use of the present product.

1. Capillary tube for dental purposes, in particular for applying small amounts of dental product in the mouth cavity, characterized in that it comprises a capillary tube (1) comprising
(i) a rear end (2) intended to be introduced into a container for adhesive or other dental filling or repair material,
(ii) a front application point (4) which is angled with regard to the main direction of the capillary tube, and
(iii) an intermediate part (3) comprising a grip and a stop.

2. Capillary tube according to claim 1, characterized in that the intermediate part is an are taped part which is a part of a circular arc.

3. Capillary tube according to claims 1-2, characterized in that it is manufactured in an opaque material.
